(19) United States
(12) Patent Application Publication
(10) Pub. No.: US 2011/0114568 A1
(43) Pub. Date: May 19, 2011

(54) System and Method for Treating Wastewater

(76) Inventors: Brian D. Mize, Rhome, TX (US); Joe B. Downing, The Colony, TX (US)

(21) Appl. No.: 13/055,493

(22) PCT Filed: Jul. 27, 2009
(86) PCT No.: PCT/US09/51826

§ 371 Date: Jan. 24, 2011

Related U.S. Application Data
(62) Division of application No. 61/085,293, filed on Jul. 31, 2008.

(51) Int. Cl. C02F 1/52; C02F 1/56

(52) U.S. Cl. 210/724; 210/199; 210/723; 210/738; 210/732

(57) ABSTRACT

A wastewater treatment system includes a chemical treatment process tank for receiving and chemically treating wastewater. The wastewater treatment system also includes a blending system for receiving and activating a flocculating agent such as a polymer. The wastewater treatment system further includes a static mixer for introducing the flocculating agent into the wastewater and for promoting flocculation of the wastewater as the wastewater flows from the chemical treatment process tank to a clarification tank.

### TECHNICAL FIELD

The present application relates to the treatment of wastewater. In particular, the present application relates to the treatment of water to remove various precipitated or suspended contaminants therefrom.

### DESCRIPTION OF PRIOR ART

Wastewater from a number of industrial operations must be treated to remove contaminants, such as metals that may pose a serious environmental problem. Many industrial water treatment plants include three basic components. Referring to FIG. 1, wastewater treatment plant 100 includes a chemical treatment process tank 102, a flocculation process tank 104, and a clarification process tank 108. The chemical treatment process tank 102 receives wastewater and stores the wastewater while it is chemically treated to convert dissolved metals into settleable metals. Next, the chemically treated wastewater is transferred to the flocculation process tank 104. The flocculation process tank 104 stores the wastewater while metals in the wastewater are bound together. Polymeric flocculation chemicals are introduced into the wastewater in the flocculation process tank 104. The flocculation chemicals cause the metals to bind together to form larger flocs or clusters that will settle easier. Finally, the wastewater containing the flocculent material is transferred downstream to the clarification process tank 104. The clarification process tank 104 allows the binded metals to fall to the bottom, while the remaining water is removed from the top.

In such conventional systems, the clarification process tank 104 must be located either on the same grade or below the flocculation process tank 102. This allows the bulked wastewater to be gravity-fed to the clarification process tank 104. If the bulked wastewater were to be pumped to a higher-grade clarification process tank, the pumping stage would break up the flocculent material in the wastewater, causing the metals to go back into solution. This significantly limits the manner in which a wastewater treatment plant can be arranged. Also, a significant amount of time is required for flocculation to occur and for the bulked wastewater to be gravity-fed for clarification.

Hence, there is a need for improvements to wastewater treatment systems and processes.

### BRIEF DESCRIPTION OF THE DRAWINGS

FIG. 1 is a schematic view of a conventional wastewater treatment system;

FIG. 2 is a schematic view of a wastewater treatment system according to the present disclosure; and

FIG. 3 is a partially-sectioned view of a static mixer suitable for use with the wastewater treatment system shown in FIG. 2.

### DESCRIPTION OF THE PREFERRED EMBODIMENT

Referring to FIG. 2 in the drawings, a schematic diagram of a wastewater treatment system 200 is shown. Wastewater treatment system 200 includes a chemical treatment process tank 202 for receiving and chemically treating waste material. When the treated material is released from the chemical treatment process tank 202, the treated material flows to a static mixer 204 that is in fluid communication with the chemical treatment process tank 202. Wastewater treatment system 200 also includes a blending system 206. The blending system 206 includes a metering pump 210 and a blending chamber 212. The blending system 206 receives polymer material from polymer storage 208, creates a polymer mixture, and provides the polymer mixture to the static mixer 204. The static mixer 204 combines the treated material received from the chemical treatment process tank 202 with the polymer mixture received from the blending system 206 as the treated material flows to a clarification tank 214.

The chemical treatment process tank 202 can be implemented as one or more storage tanks. The chemical treatment process tank 202 receives wastewater and stores the wastewater while it is chemically treated to convert dissolved metals into settleable metals. In some embodiments, the chemical treatment process tank 202 can be used to store the wastewater while the pH level of the wastewater is adjusted. For example, in embodiments where the wastewater includes chromates, the chemical treatment process tank 202 can be used for converting hexavalent chrome to trivalent chrome. The conversion process can include reducing the pH level of the wastewater, for example to a level below 3 or below 2.5, in order to acidify the wastewater. A bisulfite can be added to the wastewater in sufficient amount to cause all or substantially all of the hexavalent chrome in the wastewater to be converted to trivalent chrome. The pH level can then be raised to a level suitable for causing the chromates to form a precipitate that can settle out of the wastewater. Methods for determining an effective amount of bisulfite for achieving the desired conversion from hexavalent chrome to trivalent chrome are known by those skilled in the art. Also, methods for raising and lowering the pH level of a liquid substance are known by those skilled in the art. In alternative embodiments, the chemical treatment process tank 202 can be used for additional and/or alternative chemical processes, particularly those that result in formation of precipitates.

Once the desired chemical treatment process has been completed, the wastewater can be allowed to exit the chemical treatment process tank 202. The wastewater is directed through conduit suitable for transport of such fluids to the static mixer 204, where a polymer mixture is added and mixed with the wastewater.

The polymer mixture is provided by the blending system 206. The blending system 206 serves as a system for activating an inactive polymer, which will be used as a flocculating agent. An inactive polymer is composed of compact, coiled molecules. When combined with an appropriate fluid, such as water, the compact molecules are uncoiled and extended to expose positively and negatively charged sites. These uncoiled polymer molecules are extremely long, having millions of sites which attract charged particles suspended in the wastewater. Since most of the particles suspended in the wastewater carry a negative or positive electrostatic charge, the particles tend to aggregate with the polymer molecules to form flocs.

In some embodiments, the blending system 206 can include a polymer delivery mechanism for transferring inactive polymer from storage to the blending chamber 212. In the illustrated embodiment, the blending system 206 includes a metering pump 210, which serves as an example of a polymer delivery mechanism. While a single metering pump 210 is shown, embodiments can include one or more metering pumps 210. The metering pump 210 serves to feed polymer from the polymer storage 208 to the blending chamber 212. Embodiments of the polymer storage 208 can include one or more drums and/or tanks containing undiluted, inactive polymer in dry or liquid form. Embodiments of the metering pump 210 can include adjustable pumps that are adjustable to enable selection of the rate of flow of the polymer from polymer storage 208 to the blending chamber 212. Embodiments of the metering pump 210 can be adapted for use with various forms of polymer, for example polymer in liquid or dry form.

The blending system 206 includes a polymer activating mechanism for activating the polymer. In the illustrated embodiment, the blending system 206 includes a blending chamber 212, which serves as an example of a polymer activating mechanism. While a single blending chamber 212 is shown, embodiments can include one or more blending chambers 212. The blending chamber 212 serves to activate the inactive polymer delivered to the blending chamber 212 by the metering pump 210. The blending chamber 212 includes an inlet for receiving the inactive polymer and an inlet for receiving an activating agent such as water. The water for the blending chamber 212 is preferably clean water that is substantially free of particulate matter; in other words, it is preferable that the wastewater not be used for activating the polymer in the blending chamber 212. The blending chamber 212, or blending system 206, can include metering means for controlling the flow rate of water into the blending chamber 212. The blending chamber 212 includes a vessel into which the water and polymer are delivered and combined. The blending chamber 212 can include mixing means, for example an impeller mechanism driven by a motor, for mixing the polymer and water.

The ratio of water to polymer delivered to the blending chamber 212 can be determined by those skilled in the art according to the particular polymer that is used, for example according to the polymer manufacturer's specification. Also, the mixing time and mixing speed of the blending chamber 212 for mixing the polymer and water can be determined by those skilled in the art according to the particular polymer that is used, for example according to the polymer manufacturer's specification. It is desirable that the polymer be fully diluted and activated before it is sent to the static mixer 204, so as to allow for maximal flocculation to occur.

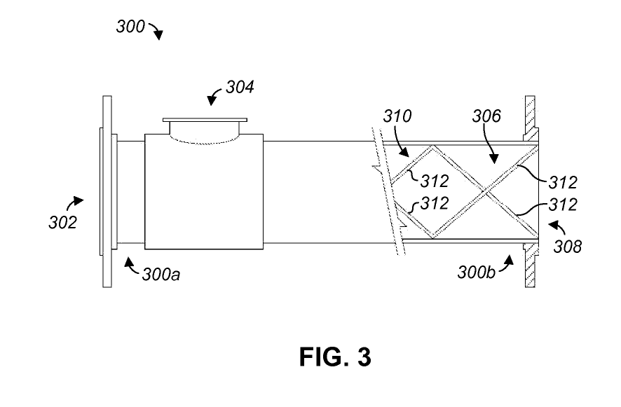

The static mixer 204 receives the activated polymer from the blending system 206 and chemically-treated wastewater from the chemical treatment process tank 202. An embodiment of a static mixer 204 is shown in FIG. 3.

Turning next to FIG. 3, a partially-sectioned view of a static mixer 300 is shown. The static mixer 300 serves as an embodiment of the static mixer 204 shown in FIG. 2. The static mixer 300 includes a first inlet port 302 and a second inlet port 304. The first inlet port 302 can be connected to conduit that is in fluid communication with the chemical treatment process tank 202. The second inlet port 304 can be connected to conduit that is in fluid communication with the blending system 206. Thus, the static mixer 300 can receive the chemically-treated wastewater from the chemical treatment process tank 202 via the first inlet port 302, and can receive the activated polymer from the blending system 206 via the second inlet port 304.

The first and second inlet ports 302 and 304 provide for fluid communication with an internal chamber 306 of the static mixer 300. The internal chamber 306 extends within the static mixer 300 between an inflow end 300a and an outflow end 300b of the static mixer 300. The static mixer 300 also includes an outlet port 308 at the outflow end 300b of the static mixer 300. A mixing element 310 is disposed within the internal chamber 306 of the static mixer 300. The mixing element 310 includes a plurality of baffles 312 for disturbing the flow of fluid as the fluid travels between the inflow end 300a and the outflow end 300b of the static mixer 300. The baffles 312 can be arranged so as to divide and recombine subdivisions of the fluid several times so as to result in a homogenous mixture being discharged from the outlet port 308. An example of a mixing element suitable for use as mixing element 310 is disclosed in U.S. Pat. No. 4,511,258 to Federighi et al., which is hereby incorporated by reference.

Turning back now to FIG. 2, the activated polymer from the blending system 206 is mixed with the chemically-treated wastewater from the chemical treatment process tank 202 as the wastewater flows through the static mixer 204. As the wastewater mixes with the activated polymer, the activated polymer acts as a flocculating agent by combining with fine particles in the wastewater. Thus, flocculation begins as the wastewater flows through the static mixer 204 so that by the time the wastewater reaches the clarification tank 214 large flocs have already formed. The static mixer 204 causes turbulent eddies in the wastewater and activated polymer that help prevent the activated polymer from settling too quickly in the conduit between the chemical treatment process tank 202 and the clarification tank 214. If the static mixer 204 was absent from the system 200, the flow of the wastewater and activated polymer would be more laminar, so the activated polymer would tend to settle in the conduit and create blockages in the conduit as the flocculation would tend to be more localized.

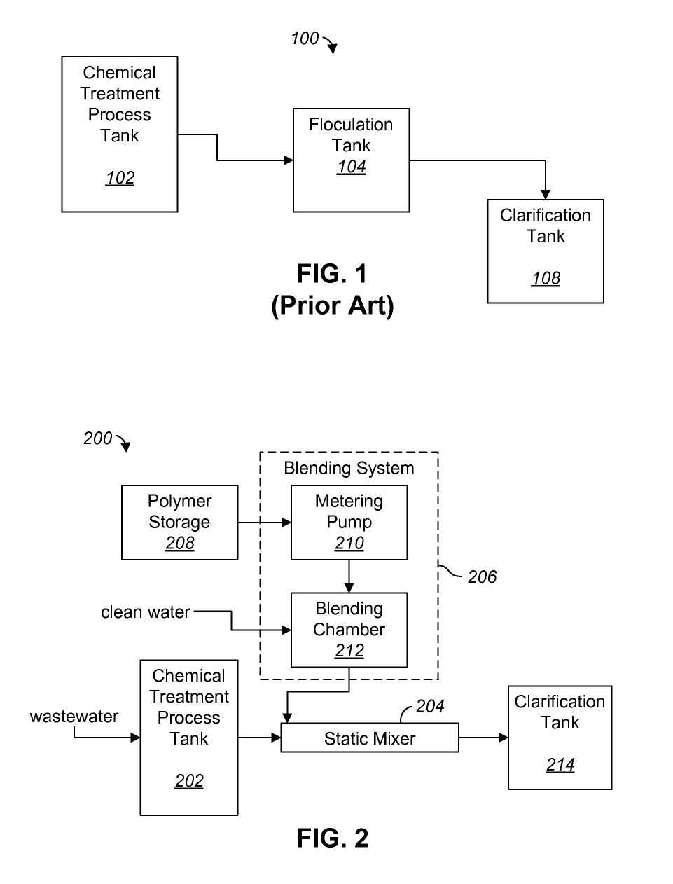

The disruptions in flow caused by the static mixer 300 allow for more even distribution of the activated polymer into the wastewater, thus allowing for flocculation to occur in a pipeline or other such conduit as the wastewater is transported to the clarification tank 214. This allows for elimination of a flocculation tank, such as the flocculation tank 104 shown in FIG. 1. Such flocculation tanks add significant expense to a wastewater treatment system, including expenses involved in building and maintaining a flocculation tank. Flocculation tanks also increase the amount of time required for treating wastewater as the wastewater is typically stored in the flocculation tank for several hours. Thus, elimination of the flocculation tank allows for wastewater treatment systems that can be built and maintained at a lower cost and that can treat wastewater in less time. Also, since flocculation occurs during transport rather than in a static flocculation tank, the wastewater can be pumped to the clarification tank 214 rather than flowing under the force of gravity. This eliminates limitations of the prior art system shown in FIG. 1, wherein the clarification tank 108 had to be located either on the same grade or below the flocculation process tank 102.

The clarification tank 214 receives the wastewater from the static mixer 300. At this point, large flocs have already begun to form in the wastewater. The flocs settle in the bottom of the clarification tank 214, separating from the liquid portion of the wastewater. The clarification tank 214 can include a number of baffles. Such baffles can help in collecting more buoyant flocs within the wastewater. The flocs will tend to collect on the bottom of the clarification tank 214, from which they can be collected for further processing or disposal. The remaining liquid of the wastewater can be removed from the top of the clarification tank 214 for further processing or disposal.

It is apparent that an invention with significant advantages has been described and illustrated. Although the present application is shown in a limited number of forms, it is not limited to just these forms, but is amenable to various changes and modifications without departing from the spirit thereof.

1. A system for treating wastewater, the system comprising:
a chemical treatment process tank for receiving wastewater and allowing for chemical treatment of the wastewater, thereby providing chemically-treated wastewater;
a blending system for receiving a flocculating agent and activating the flocculating agent, thereby providing an activated flocculating agent;
a clarification tank; and
a static mixer for introducing the activated flocculating agent into the chemically-treated wastewater and for promoting flocculation of the chemically-treated wastewater while the chemically-treated wastewater flows from the chemical treatment process tank to the clarification tank.

2. The system according to claim 1, wherein the chemical treatment of the wastewater includes chemical treatment for promoting the formation of precipitates.

3. The system according to claim 2, wherein the chemical treatment of the wastewater includes changing the pH level of the wastewater.

4. The system according to claim 3, wherein the chemical treatment of the wastewater includes reducing the pH level of the wastewater and subsequently raising the pH level of the wastewater.

5. The system according to claim 1, wherein the flocculating agent includes a polymer.

6. The system according to claim 5, wherein the blending system comprises a polymer delivery mechanism and a polymer activating mechanism.

7. The system according to claim 1, wherein the blending system comprises a blending chamber for combining an activating agent with the flocculating agent.

8. The system according to claim 7, wherein the blending chamber comprises a mixing device for mixing the activating agent and the flocculating agent, thereby promoting activation of the flocculating agent.

9. The system according to claim 1, wherein the blending system comprises a metering pump for controlling the receiving of the flocculating agent.

10. The system according to claim 1, wherein the clarification tank comprises one or more baffles.

11. The system according to claim 1, wherein the static mixer comprises a first inlet port for receiving the chemically-treated wastewater from the chemical treatment process tank, and a second inlet port for receiving the activated flocculating agent from the blending system.

12. The system according to claim 1, wherein the static mixer comprises an internal chamber and a mixing element disposed within the internal chamber, the mixing element being configured for mixing the activated flocculating agent and the chemically-treated wastewater.

13. A method of treating wastewater, the method comprising:
receiving wastewater at a static mixer,
wherein the static mixer comprises an inlet port for receiving the wastewater and an outlet port in fluid communication with a clarification tank; and
receiving an activated flocculating agent at the static mixer,
wherein the static mixer is configured for causing the activated flocculating agent to mix with the wastewater while the wastewater flows from the inlet port of the static mixer to the clarification tank, thereby promoting flocculation of the wastewater while the wastewater flows to the clarification tank.

14. The method according to claim 13, further comprising chemically treating the wastewater for promoting the formation of precipitates in the wastewater before the wastewater is received by the static mixer.

15. The method according to claim 14, wherein the chemical treatment of the wastewater includes changing the pH level of the wastewater.

16. The method according to claim 15, wherein the chemical treatment of the wastewater includes reducing the pH level of the wastewater and subsequently raising the pH level of the wastewater.

17. The method according to claim 13, wherein the activated flocculating agent includes a polymer.

18. The method according to claim 13, further comprising activating an inactive flocculating agent using a blending system that comprises a blending chamber for combining an activating agent with the inactive flocculating agent, thereby providing at least some of the activated flocculating agent.

19. The method according to claim 13, wherein the inlet port of the static mixer is a first inlet port for receiving the wastewater, and wherein the static mixer further comprises a second inlet port for receiving the activated flocculating agent.

20. The method according to claim 13, wherein the static mixer comprises an internal chamber and a mixing element disposed within the internal chamber, the mixing element being configured for mixing the activated flocculating agent and the wastewater.
